(19) United States
(12) Patent Application Publication
(10) Pub. No.: US 2026/0093492 A1
(43) Pub. Date: Apr. 2, 2026

(54) PERFORMING CRITICALITY-BASED INSTRUCTION SCHEDULING IN PROCESSOR DEVICES

(71) Applicant: QUALCOMM Incorporated, San Diego, CA (US)

(72) Inventor: Suryanarayana Murthy Durbhakula, Hyderabad (IN)

(21) Appl. No.: 18/901,392

(22) Filed: Sep. 30, 2024

(51) Int. Cl. G06F 9/30; G06F 9/48

(52) U.S. Cl. CPC G06F 9/30185; G06F 9/4881

(57) ABSTRACT

Performing criticality-based instruction scheduling in processor devices is disclosed herein. In some aspects, a processor device executes a compiler that generates an initial schedule comprising a plurality of instructions. The compiler constructs a directed graph based on the initial schedule, with each directed graph node corresponding to an instruction of the plurality of instructions, and each directed edge of the directed graph indicating an instruction dependency. The compiler calculates criticality metrics for each directed graph node, and generates a max heap data structure based on the criticality metrics. The compiler determines an optimized schedule comprising the plurality of instructions by iteratively identifying a root node of the max heap data structure as a node having a highest criticality metric, scheduling an instruction corresponding to the root node, and removing the root node from the max heap data structure. The processor device then executes the instructions according to the optimized schedule.

### TECHNICAL FIELD

The technology of the disclosure relates generally to compiler instruction scheduling algorithms used by processor devices, and, in particular, to generating more optimal instruction schedules based on instruction criticality.

### BACKGROUND

Instruction scheduling is an optimization technique performed by conventional compilers for improving the performance of a computer program by arranging the computer-executable instructions that make up the computer program to maximize the utilization of processor resources. Effective instruction scheduling can reduce instruction pipeline stalls caused by instruction dependencies, enhance instruction-level parallelism, improve cache performance, and/or reduce branch predictions and pipeline flushes. In general, instruction scheduling involves identifying dependencies between instructions in an instruction block, applying a scheduling algorithm to reorder the instructions in a manner that preserves the computer program's functionality, and finally generating an instruction schedule that reflects the results of the scheduling algorithm.

However, instruction schedules generated using conventional instruction scheduling algorithms may still result in suboptimal ordering of instructions. In particular, conventional scheduling algorithms may produce instruction schedules in which instructions are still generally in program order (taking instruction dependencies into account) when further reordering may produce a more optimal ordering. Accordingly, an instruction scheduling algorithm that results in a more efficient ordering of instructions is desirable.

### SUMMARY OF THE DISCLOSURE

Aspects disclosed in the detailed description include performing criticality-based instruction scheduling in processor devices. Related apparatus, methods, and computer-readable media are also disclosed. In this regard, in some exemplary aspects disclosed herein, a processor device is configured to execute a compiler that takes into account the criticality of instructions when generating a more optimal instruction schedule. As used herein, the “criticality” of a given instruction X refers to a metric that indicates a total number of processor cycles (i.e. “instruction latency”) consumed by instructions that are dependent, either directly or indirectly, on execution of the instruction X, with higher values indicating a higher criticality. “Instruction dependency” as used herein refers to a relationship between a pair of instructions wherein a first instruction of the pair depends on the result of a previous second instruction to generates its own result (as opposed to “program dependency,” which refers to an analogous relationship between subportions of a program such as functions or modules).

Accordingly, in exemplary operation, the compiler first generates an initial schedule (i.e., using conventional instruction scheduling algorithms) comprising a plurality of instructions. The compiler then constructs a directed graph based on the initial schedule, with each node of the directed graph corresponding to an instruction of the plurality of instructions, and each directed edge of the directed graph indicating an instruction dependency between pairs of instructions. The compiler next calculates a criticality metric for each node of the directed graph, representing the criticality of the instruction corresponding to the node. Using the criticality metrics as a key, the compiler generates a max heap data structure, with the root node of the max heap data structure corresponding to the instruction having the highest criticality metric.

The compiler then determines an optimized schedule comprising the plurality of instructions by iteratively performing a series of operations. The compiler first identifies the root node of the max heap data structure as the node having the highest criticality metric, and schedules the instruction corresponding to the root node. The compiler then removes the root node from the max heap data structure. These operations are repeated until all of the nodes have been removed from the max heap data structure, at which point the processor device executes the plurality of instructions according to the optimized schedule.

According to some aspects, the operations for determining the optimized schedule may further include the compiler determining, based on the directed graph, whether the instruction corresponding to the root node depends on an unscheduled instruction (e.g., where the instruction has a program dependency on the unscheduled instruction). If so, the compiler schedules the unscheduled instruction prior to scheduling the instruction corresponding to the root node, and removes the node corresponding to the unscheduled instruction from the max heap data structure. Some aspects may provide that, when determining the optimized schedule, the compiler may schedule the instruction corresponding to the root node responsive to determining that a functional unit corresponding to a type of the instruction corresponding to the root node is available. If the functional unit corresponding to the type of the instruction corresponding to the root node is not available, the compiler in some such aspects may schedule a next-most-critical instruction for which a corresponding functional unit is available, and remove a node corresponding to the next-most-critical instruction. In some aspects, after removing the root node of the max heap data structure, the compiler may also rebalance the max heap data structure. During the rebalancing, the compiler in some such metrics may identify two or more nodes of the max heap data structure as having the same highest criticality metric. In that case, the compiler selects a node of the two or more nodes that corresponds to a longest instruction latency as the root node. Some aspects may provide that determining the optimized schedule may further comprise the compiler reordering the plurality of instructions to perform load latency hiding.

In another aspect, a processor device is disclosed. The processor device is configured to generate, by executing a compiler, an initial schedule comprising a plurality of instructions. The processor device is further configured to construct, by executing the compiler, a directed graph based on the initial schedule, wherein each node of a first plurality of nodes of the directed graph corresponds to an instruction of the plurality of instructions, and each directed edge of one or more directed edges of the directed graph indicates an instruction dependency. The processor device is also configured to calculate, by executing the compiler, a plurality of criticality metrics corresponding to the first plurality of nodes. The processor device is additionally configured to generate, by executing the compiler, a max heap data structure comprising a second plurality of nodes based on the plurality of criticality metrics. The processor device is further configured to determine, by executing the compiler, an optimized schedule comprising the plurality of instructions by being configured to iteratively identify a root node of the max heap data structure as a node of the second plurality of nodes having a highest criticality metric, schedule an instruction of the plurality of instructions corresponding to the root node, and remove the root node from the max heap data structure. The processor device is also configured to execute the plurality of instructions according to the optimized schedule.

In another aspect, a processor device is disclosed. The processor device comprises means for generating an initial schedule comprising a plurality of instructions. The processor device further comprises means for constructing a directed graph based on the initial schedule, wherein each node of a first plurality of nodes of the directed graph corresponds to an instruction of the plurality of instructions, and each directed edge of one or more directed edges of the directed graph indicates an instruction dependency. The processor device also comprises means for calculating a plurality of criticality metrics corresponding to the first plurality of nodes. The processor device also additionally comprises means for generating a max heap data structure comprising a second plurality of nodes based on the plurality of criticality metrics. The processor device further comprises means for determining an optimized schedule comprising the plurality of instructions by iteratively identifying a root node of the max heap data structure as a node of the second plurality of nodes having a highest criticality metric, scheduling an instruction of the plurality of instructions corresponding to the root node, and removing the root node from the max heap data structure. The processor device also comprises means for executing the plurality of instructions according to the optimized schedule.

In another aspect, a method for performing criticality-based instruction scheduling in processor devices is disclosed. The method comprises generating, by a compiler executing on a processor device, an initial schedule comprising a plurality of instructions. The method further comprises constructing, by the compiler, a directed graph based on the initial schedule, wherein each node of a first plurality of nodes of the directed graph corresponds to an instruction of the plurality of instructions, and each directed edge of one or more directed edges of the directed graph indicates an instruction dependency. The method also comprises calculating, by the compiler, a plurality of criticality metrics corresponding to the first plurality of nodes. The method additionally comprises generating, by the compiler, a max heap data structure comprising a second plurality of nodes based on the plurality of criticality metrics. The method further comprises determining, by the compiler, an optimized schedule comprising the plurality of instructions by iteratively identifying a root node of the max heap data structure as a node of the second plurality of nodes having a highest criticality metric, scheduling an instruction of the plurality of instructions corresponding to the root node, and removing the root node from the max heap data structure. The method also comprises executing, by the processor device, the plurality of instructions according to the optimized schedule.

In another aspect, a non-transitory computer-readable medium is disclosed. The non-transitory computer-readable medium stores computer-executable instructions that, when executed, cause a processor device to generate an initial schedule comprising a plurality of instructions. The computer-executable instructions further cause the processor device to construct a directed graph based on the initial schedule, wherein each node of a first plurality of nodes of the directed graph corresponds to an instruction of the plurality of instructions, and each directed edge of one or more directed edges of the directed graph indicates an instruction dependency. The computer-executable instructions also cause the processor device to calculate a plurality of criticality metrics corresponding to the first plurality of nodes. The computer-executable instructions additionally cause the processor device to generate a max heap data structure comprising a second plurality of nodes based on the plurality of criticality metrics. The computer-executable instructions further cause the processor device to determine an optimized schedule comprising the plurality of instructions by causing the processor device to iteratively identify a root node of the max heap data structure as a node of the second plurality of nodes having a highest criticality metric, schedule an instruction of the plurality of instructions corresponding to the root node, and remove the root node from the max heap data structure. The computer-executable instructions also cause the processor device to execute the plurality of instructions according to the optimized schedule.

### BRIEF DESCRIPTION OF THE FIGURES

FIG. 1 is a diagram of an exemplary processor-based system that includes a processor device with an instruction processing circuit configured to execute a compiler to perform criticality-based instruction scheduling, according to some aspects;

FIG. 2 illustrates an exemplary initial schedule generated by compiler of FIG. 1 and used as a starting point for determining an optimized schedule based on criticality-based instruction scheduling, according to some aspects;

FIG. 3 illustrates an exemplary directed graph generated by the compiler of FIG. 1 based on the exemplary initial schedule of FIG. 2, according to some aspects;

FIG. 4 illustrates an exemplary max heap data structure generated by compiler of FIG. 1 based on the exemplary directed graph of FIG. 3, according to some aspects;

FIG. 5 illustrates an exemplary optimized schedule generated by the compiler based on the exemplary directed graph of FIG. 3 and the exemplary max heap data structure of FIG. 4, according to some aspects;

FIGS. 6A-6D are flowcharts illustrating exemplary operations performed by the processor device of FIG. 1 for performing criticality-based instruction scheduling, according to some aspects; and

FIG. 7 is a block diagram of an exemplary processor-based device that can include the processor device of FIG. 1.

### DETAILED DESCRIPTION

With reference now to the drawing figures, several exemplary aspects of the present disclosure are described. The word “exemplary” is used herein to mean “serving as an example, instance, or illustration. ” Any aspect described herein as “exemplary” is not necessarily to be construed as preferred or advantageous over other aspects. The terms “first,” “second,” and the like used herein are intended to distinguish between similarly named elements, and do not indicate an ordinal relationship between such elements unless otherwise expressly indicated.

Aspects disclosed in the detailed description include performing criticality-based instruction scheduling in processor devices. Related apparatus, methods, and computer-readable media are also disclosed. In this regard, in some exemplary aspects disclosed herein, a processor device is configured to execute a compiler that takes into account the criticality of instructions when generating a more optimal instruction schedule. As used herein, the “criticality” of a given instruction X refers to a metric that indicates a total number of processor cycles (i.e. “instruction latency”) consumed by instructions that are dependent, either directly or indirectly, on execution of the instruction X, with higher values indicating a higher criticality. “Instruction dependency” as used herein refers to a relationship between a pair of instructions wherein a first instruction of the pair depends on the result of a previous second instruction to generates its own result (as opposed to “program dependency,” which refers to an analogous relationship between subportions of a program such as functions or modules).

Accordingly, in exemplary operation, the compiler first generates an initial schedule (i.e., using conventional instruction scheduling algorithms) comprising a plurality of instructions. The compiler then constructs a directed graph based on the initial schedule, with each node of the directed graph corresponding to an instruction of the plurality of instructions, and each directed edge of the directed graph indicating an instruction dependency between pairs of instructions. The compiler next calculates a criticality metric for each node of the directed graph, representing the criticality of the instruction corresponding to the node. Using the criticality metrics as a key, the compiler generates a max heap data structure, with the root node of the max heap data structure corresponding to the instruction having the highest criticality metric.

The compiler then determines an optimized schedule comprising the plurality of instructions by iteratively performing a series of operations. The compiler first identifies the root node of the max heap data structure as the node having the highest criticality metric, and schedules the instruction corresponding to the root node. The compiler then removes the root node from the max heap data structure. These operations are repeated until all of the nodes have been removed from the max heap data structure, at which point the processor device executes the plurality of instructions according to the optimized schedule.

According to some aspects, the operations for determining the optimized schedule may further include the compiler determining, based on the directed graph, whether the instruction corresponding to the root node depends on an unscheduled instruction (e.g., where the instruction has a program dependency on the unscheduled instruction). If so, the compiler schedules the unscheduled instruction prior to scheduling the instruction corresponding to the root node, and removes the node corresponding to the unscheduled instruction from the max heap data structure. Some aspects may provide that, when determining the optimized schedule, the compiler may schedule the instruction corresponding to the root node responsive to determining that a functional unit corresponding to a type of the instruction corresponding to the root node is available. If the functional unit corresponding to the type of the instruction corresponding to the root node is not available, the compiler in some such aspects may schedule a next-most-critical instruction for which a corresponding functional unit is available, and remove a node corresponding to the next-most-critical instruction. In some aspects, after removing the root node of the max heap data structure, the compiler may also rebalance the max heap data structure. During the rebalancing, the compiler in some such metrics may identify two or more nodes of the max heap data structure as having the same highest criticality metric. In that case, the compiler selects a node of the two or more nodes that corresponds to a longest instruction latency as the root node. Some aspects may provide that determining the optimized schedule may further comprise the compiler reordering the plurality of instructions to perform load latency hiding.

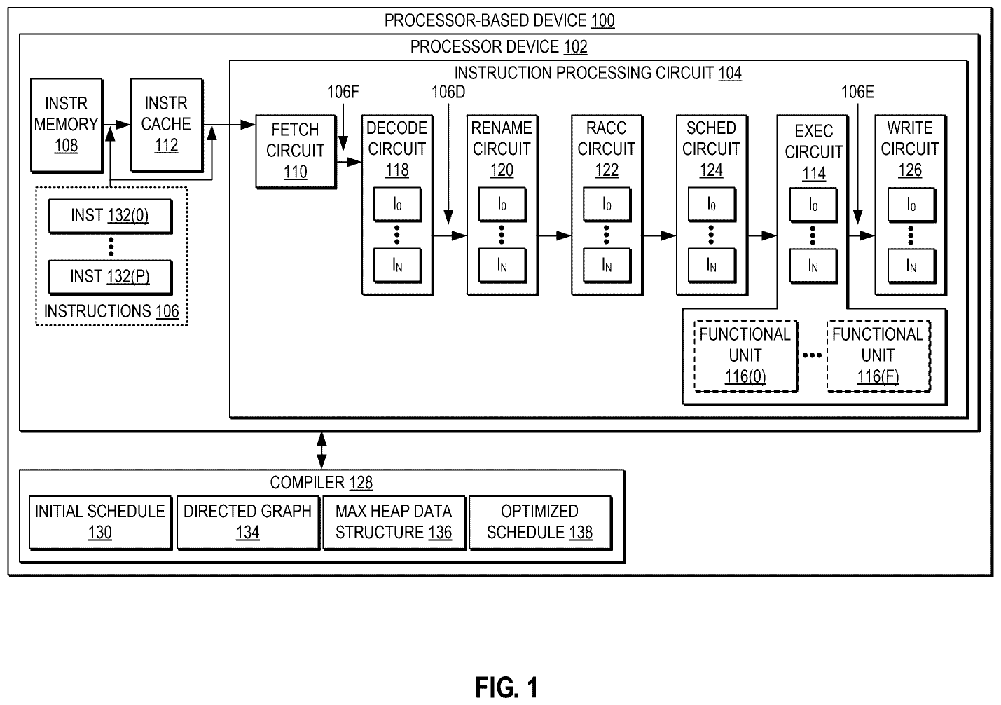

In this regard, FIG. 1 is a diagram of an exemplary processor-based device 100 that includes a processor device 102. The processor device 102, which also may be referred to as a “processor core” or a “central processing unit (CPU) core,” may be an in-order or an out-of-order processor (OoP), and/or may be one of a plurality of processor devices 102 provided by the processor-based device 100. In the example of FIG. 1, the processor device 102 includes an instruction processing circuit 104 that comprises one or more instruction pipelines I₀-I_{N} for processing the instructions 106 fetched from an instruction memory (captioned as “INSTR MEMORY” in FIG. 1) 108 by a fetch circuit 110 for execution. The instruction memory 108 may be provided in or as part of a system memory in the processor-based device 100, as a non-limiting example. An instruction cache (captioned as “INSTR CACHE” in FIG. 1) 112 may also be provided in the processor device 102 to cache the instructions 106 fetched from the instruction memory 108 to reduce latency in the fetch circuit 110.

The fetch circuit 110 in the example of FIG. 1 is configured to provide the instructions 106 as fetched instructions 106F into the one or more instruction pipelines I₀-I_{N} in the instruction processing circuit 104 to be pre-processed, before the fetched instructions 106F reach an execution circuit (captioned as “EXEC CIRCUIT” in FIG. 1) 114 to be executed. The execution circuit 114 in the example of FIG. 1 comprises a plurality of functional units 116(0)-116(F) to facilitate instruction execution. Each of the functional units 116(0)-116(F) may comprise, as non-limiting examples, an arithmetic logic unit (ALU), a load/store unit, an integer multiplier unit, a floating-point divider unit, or other special-purpose unit, and may be used to execute an instruction of the fetched instructions 106F having a type corresponding to the functional unit 116(0)-116(F). The instruction pipelines I₀-I_{N} are provided across different processing circuits or stages of the instruction processing circuit 104 to pre-process and process the fetched instructions 106F in a series of steps that can be performed concurrently to increase throughput prior to execution of the fetched instructions 106F by the execution circuit 114.

With continuing reference to FIG. 1, the instruction processing circuit 104 includes a decode circuit 118 configured to decode the fetched instructions 106F fetched by the fetch circuit 110 into decoded instructions 106D to determine the instruction type and actions required. The instruction type and action required encoded in the decoded instruction 106D may also be used to determine in which instruction pipeline I₀-I_{N} the decoded instructions 106D should be placed. In this example, the decoded instructions 106D are placed in one or more of the instruction pipelines I₀-I_{N} and are next provided to a rename circuit 120 in the instruction processing circuit 104. The rename circuit 120 is configured to determine if any register names in the decoded instructions 106D should be renamed to decouple any register dependencies that would prevent parallel or out-of-order processing.

The instruction processing circuit 104 in the processor device 102 in FIG. 1 also includes a register access circuit (captioned as “RACC CIRCUIT” in FIG. 1) 122. The register access circuit 122 is configured to access physical registers (not shown) in a physical register file (PRF) (not shown). Each of the physical registers has a corresponding physical register number (not shown) that can be mapped to a logical register number using, e.g., mapping entries of a register mapping table (RMT) (not shown). In this manner, the register access circuit 122 can access a source register operand of a decoded instruction 106D to retrieve a produced value from an executed instruction 106E in the execution circuit 114. The register access circuit 122 is also configured to provide the retrieved produced value from an executed instruction 106E as the source register operand of a decoded instruction 106D to be executed.

The instruction processing circuit 104 further includes a scheduler circuit (captioned as “SCHED CIRCUIT” in FIG. 1) 124 in the instruction pipeline I₀-I_{N}, which is configured to store decoded instructions 106D in reservation entries (not shown) until all source register operands for the decoded instruction 106D are available. The scheduler circuit 124 issues decoded instructions 106D that are ready to be executed to the execution circuit 114. A write circuit 126 is also provided in the instruction processing circuit 104 to write back or commit produced values from executed instructions 106E to memory (such as the PRF), cache memory, or system memory.

To maximize the utilization of processor resources of the processor device 102, the processor device 102 may execute a compiler 128 that generates an initial schedule 130, using conventional instruction scheduling algorithms, that represents an order in which groups of instructions among the instructions 106, such as instructions (captioned as “INST” in FIG. 1) 132(0)-132(P), are executed by the processor device 102. The instructions 132(0)-132(P) may represent, e.g., an instruction block within the instructions 106 that is determined by the compiler 128 to end with a branch instruction. As noted above, conventional instruction scheduling algorithms such as those used by the compiler 128 to generate the initial schedule 130 take into account factors such as instruction dependencies when reordering the instructions 132(0)-132(P). It is recognized, though, that the initial schedule 130 may still result in a suboptimal ordering of the instructions 132(0)-132(P) if factors such as the criticality of the instructions 132(0)-132(P) are not taken into account by the compiler 128. For example, if the instructions 132(0)-132(P) include instructions X₁, X₂, and X₃, the initial schedule 130 may provide that X₁, X₂, and X₃ are executed in program order. However, if no dependencies exist between X₁, X₂, and X₃, and X₃ has a higher criticality than X₂ and X₂ has a higher criticality than X₁, higher performance can be achieved if X₃ is scheduled first, followed X₂ and then X₁.

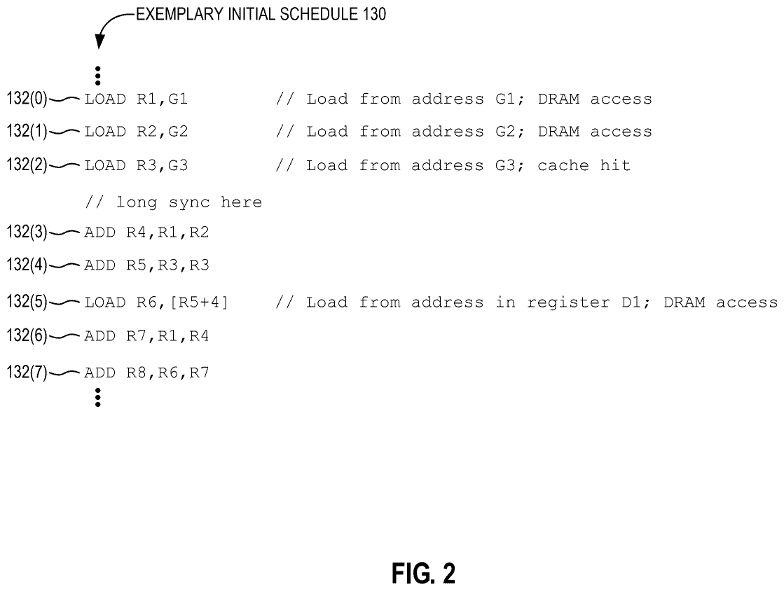

In this regard, the processor device 102 is configured to execute the compiler 128 to perform criticality-based instruction scheduling. As discussed in greater detail below with respect to FIGS. 2-5, the compiler 128 in exemplary operation generates the initial schedule 130 comprising the plurality of instructions 132(0)-132(P). The compiler 128 next constructs a directed graph 134 based on the initial schedule 130, with each node of the directed graph 134 corresponding to an instruction of the plurality of instructions 132(0)-132(P), and each directed edge of the directed graph 134 indicating an instruction dependency. The compiler 128 calculates a plurality of criticality metrics (not shown) corresponding to each node of the directed graph 134, and then generates a max heap data structure 136 based on the plurality of criticality metrics. As used herein, a “max heap data structure” is a binary tree data structure for which the key (i.e., the criticality metric) of each node in the binary tree is greater than or equal to the values of the key of each child node, with the root node of the binary tree having the largest key value.

The compiler 128 next determines an optimized schedule 138 comprising the plurality of instructions 132(0)-132(P) by iteratively performing a series of operations. The compiler 128 first identifies a root node of the max heap data structure 136 as a node having a highest criticality metric. The compiler schedules the instruction of the plurality of instructions 132(0)-132(P) corresponding to the root node, and then removes the root node from the max heap data structure 136. This process is repeated until no nodes remain in the max heap data structure 136. The processor device 102 then executes the plurality of instructions 132(0)-132(P) in the order indicated by the optimized schedule 138.

FIG. 2 illustrates an exemplary initial schedule 130 that may be generated by the compiler 128 of FIG. 1 based on the plurality of instructions 132(0)-132(P) of FIG. 1. As seen in FIG. 2, the initial schedule 130 in this example includes the instructions 132(0)-132(7) (i.e., P=7 in this example). It is assumed for purposes of illustration that instructions that require a Dynamic Random Access Memory (DRAM) access have an instruction latency of 100 processor cycles, while ADD and LOAD instructions and instructions that result in a cache hit have an instruction latency of one (1) processor cycle. Note that in this example, the instructions 132(0) and 132(1) each have an instruction latency of 100 processor cycles and the instruction 132(2) has an instruction latency of 1 processor cycle. However, because the instructions 132(0)-132(2) are performed in parallel followed by a long sync, the instructions 132(0)-132(2) together consume a total of 100 processor cycles. Executing the instructions 132(0)-132(7) according to the initial schedule 130 therefore consumes a total of 204 processor cycles. Note further that both the instruction 132(4) and the instruction 132(5) (which also requires a DRAM access and thus has an instruction latency of 100 processor cycles) both depend on the instruction 132(2).

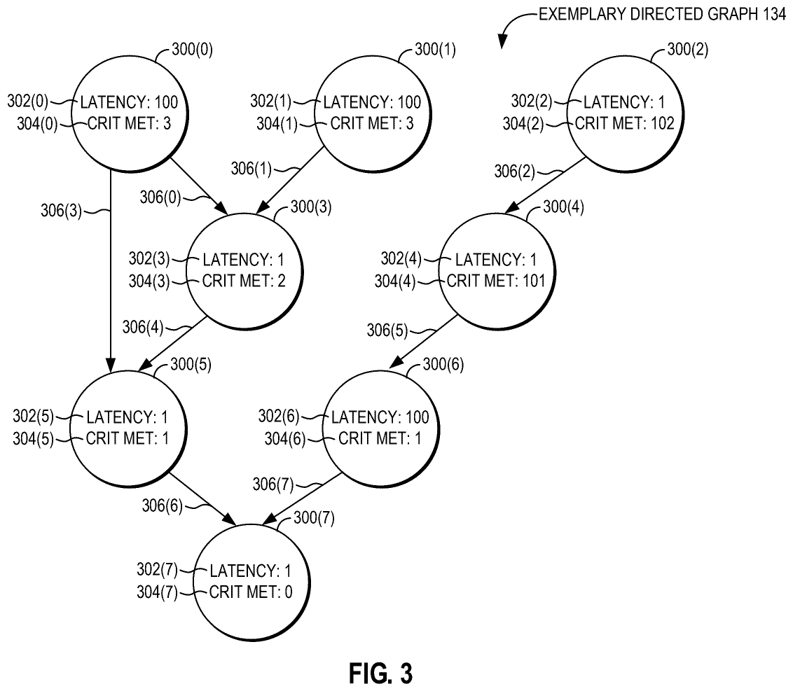

In FIG. 3, an exemplary directed graph 134 that may be generated by the compiler 128 of FIG. 1 based on the initial schedule 130 and the instructions 132(0)-132(7) of FIG. 2 is shown. The directed graph 134 comprises a plurality of nodes 300(0)-300(7), each of which corresponds to an instruction of the plurality of instructions 132(0)-132(7) of FIG. 2. The nodes 300(0)-300(7) are associated with corresponding instruction latencies (captioned as “LATENCY” in FIG. 3) 302(0)-302(7) and corresponding criticality metrics (captioned as “CRIT MET” in FIG. 3) 304(0)-304(7) for the corresponding instructions 132(0)-132(7). Thus, the nodes 300(0), 300(1), and 300(6), corresponding to the instructions 132(0), 132(1), and 132(6), respectively, have instruction latencies 302(0), 302(1), and 302(6), respectively, with a value of 100. The nodes 300(2), 300(3), 300(4), 300(5), and 300(7), corresponding to the instructions 132(2), 132(3), 132(4), 132(5), and 132(7), respectively, have instruction latencies 302(2), 302(3), 302(4), 302(5), and 302(7), respectively, with a value of one (1).

The directed graph 134 further comprises a plurality of directed edges 306(0)-306(7) that connect pairs of the nodes 300(0)-300(7) to indicate dependencies between corresponding pairs of the instructions 132(0)-132(7). Accordingly, as seen in FIG. 3, the directed edges 306(0) and 306(1) connecting the nodes 300(0) and 300(1), respectively, with the node 300(3) indicates that the instruction 132(3) is dependent on the instructions 132(0) and 132(1). The directed edge 306(2) connecting the node 300(2) with the node 300(4) indicates that the instruction 132(4) is dependent on the instruction 132(2). The directed edges 306(3) and 306(4) connecting the nodes 300(0) and 300(3), respectively, with the node 300(5) indicate that the instruction 132(5) is dependent on the instructions 132(0) and 132(3). The directed edge 306(5) connecting the node 300(4) with the node 300(6) indicates that the instruction 132(6) is dependent on the instruction 132(4). Finally, the directed edges 306(6) and 306(7) connecting the nodes 300(5) and 300(6), respectively, with the node 300(7) indicate that the instruction 132(7) is dependent on the instructions 132(5) and 132(6).

As noted above with respect to FIG. 1, the compiler 128 generates the plurality of criticality metrics 304(0)-304(7) for the nodes 300(0)-300(7) (and, in turn, the corresponding instructions 132(0)-132(7)) based on the directed graph 134. This is accomplished for each of the nodes 300(0)-300(7) by traversing the directed graph 134 and calculating a sum of instruction latencies 302(0)-302(7) for each “downstream” node representing a direct or indirect dependency. For example, the directed graph 134 indicates that the nodes 300(3), 300(5), and 300(7), representing the instructions 132(3), 132(5), and 132(7), respectively, depend directly or indirectly on the node 300(0) corresponding to the instruction 132(0). The instruction latencies 302(3), 302(5), and 302(7) of the nodes 300(3), 300(5), and 300(7), respectively, each have a value of one (1), resulting in a sum of three (3) for the criticality metric 304(0) of the node 300(0). Similarly, the nodes 300(4), 300(6), and 300(7), representing the instructions 132(4), 132(6), and 132(7), respectively, depend directly or indirectly on the node 300(2) corresponding to the instruction 132(2). The instruction latencies 302(4), 302(6), and 302(7) of the nodes 300(4), 300(6), and 300(7), respectively, have values of one (1), 100, and one (1), respectively, resulting in a sum of 102 for the criticality metric 304(2) of the node 300(2).

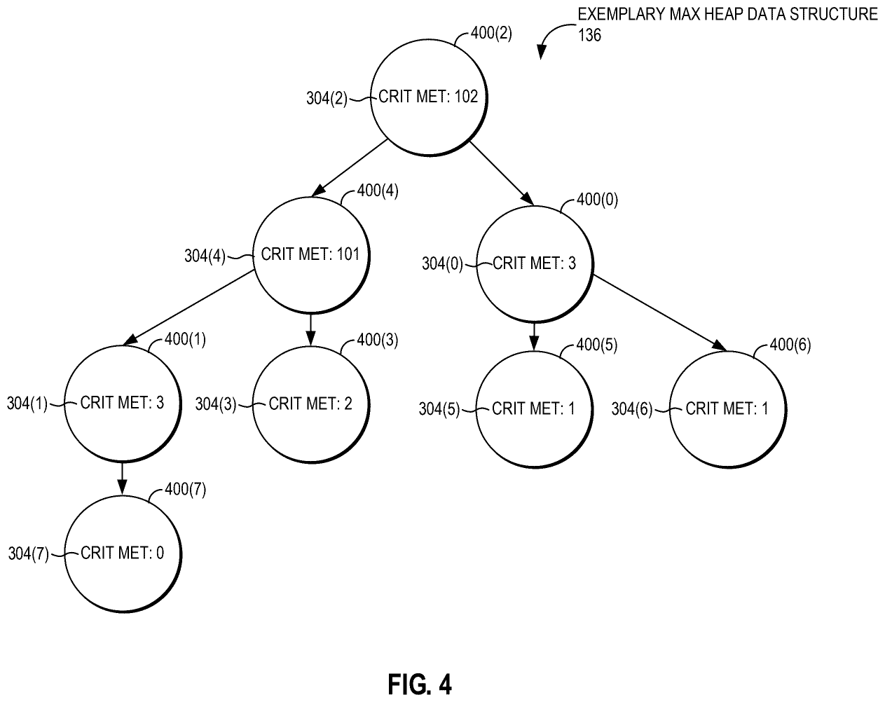

The directed graph 134 of FIG. 3 is used by the compiler 128 of FIG. 1 to generate the exemplary max heap data structure 136 shown in FIG. 4. The max heap data structure 136 of FIG. 4 is a binary tree comprising a plurality of nodes 400(0)-400(7) corresponding to the nodes 300(0)-300(7) of the directed graph 134 and the respective instructions 132(0)-132(7) of FIG. 2. The max heap data structure 136 employs the criticality metrics (captioned as “CRIT MET” in FIG. 4) 304(0)-304(7) of FIG. 3 as a key for the nodes 400(0)-400(7), and is organized such that the criticality metric 304(0)-304(7) of each node 400(0)-400(7) is greater than or equal than the criticality metric 304(0)-304(7) of each child node. This results in the root node of the max heap data structure 136 having the largest criticality metric. In the example of FIG. 4, the node 400(2), with a criticality metric 304(2), is the root node 400(2) of the max heap data structure 136.

To determine the optimized schedule 138 of FIG. 1, the compiler 128 iteratively performs a series of operations using the max heap data structure 136. The compiler 128 first identifies the root node (the root node 400(2), in the example of FIG. 4) of the max heap data structure 136 as a node having a highest criticality metric (the criticality metric 304(2), in the example of FIG. 4). The compiler 128 then schedules the instruction corresponding to the root node 400(2) (i.e., the instruction 132(2)).

In some circumstances, one or more other instructions may need to be scheduled before the instruction 132(2) due to program dependencies, even though each of the one or more other instructions may have a lower criticality metric than the criticality metric 304(2) of the instruction 132(2). For example, the instruction 132(2) may have a program dependency on, e.g., the instruction 132(0), such that the instruction 132(0) must execute first even though the criticality metric 304(0) of the instruction 132(0) is lower than the criticality metric 304(2) of the instruction 132(2). Thus, some aspects may provide that, before scheduling the instruction 132(2), the compiler 128 may determine whether the instruction 132(2) depends on an unscheduled instruction such as the instruction 132(0) of the plurality of instructions 132(0)-132(P), based on the directed graph 134. If so, the compiler 128 schedules the unscheduled instruction 132(0) prior to scheduling the instruction 132(2) corresponding to the root node 400(2), and also removes the node 400(0) corresponding to the unscheduled instruction 132(0) from the max heap data structure 136. Some aspects may provide that the compiler 128 determines whether a functional unit, such as the functional unit 116(0) of FIG. 1, corresponding to a type of the instruction 132(2) corresponding to the root node 400(2) is available, and will only schedule the instruction 132(2) if the functional unit 116(0) is available. Otherwise, the compiler 128 according to some such aspects may schedule a next-most-critical instruction, such as the instruction 132(4), for which a corresponding functional unit such as the functional unit 116(F) is available, and remove the node 400(4) corresponding to the next-most-critical instruction 132(4) from the max heap data structure 136. This avoids the need for the compiler 128 to insert a no-operation (NOP) instruction, which would increase execution time and result in a sub-optimal instruction schedule.

The compiler 128 next removes the root node 400(2) from the max heap data structure 136. Upon removing the root node 400(2), the compiler 128 in some aspects may rebalance the max heap data structure (i.e., using conventional techniques) so that a node having the next highest criticality metric (in this example, the node 400(4) with the criticality metric 304(4)) is the new root node. In the case where multiple nodes have the same next highest criticality metric, the compiler 128 according to some aspects may select a node that corresponds to a longest instruction latency. For example, if the max heap data structure 136 contains only the nodes 400(5), 400(6), and 400(7), the compiler 128 will need to select one of the nodes 400(5) and 400(6) as the new root node. In this case, the compiler 128 will select the node 400(5) as the new root node 400(5) because it corresponds to the instruction 132(5) with the longest instruction latency 302(5) among the instructions 132(5), 132(6) and 132(7) corresponding to the remaining nodes 400(5), 400(6), and 400(7) of the max heap data structure 136.

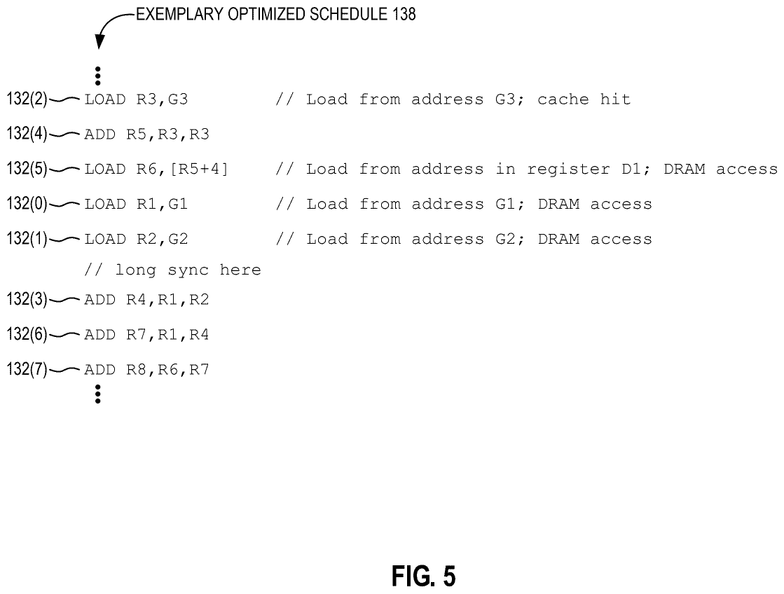

The process detailed above is repeated until no nodes remain in the max heap data structure 136. After the max heap data structure 136 is empty, the compiler 128 according to some aspects may further reorder the plurality of instructions 132(0)-132(P) to perform load latency hiding. An example of the benefits of load latency hiding is illustrated below with respect to FIG. 5.

FIG. 5 illustrates an exemplary optimized schedule 138 that may be generated by the compiler 128 of FIG. 1 based on the exemplary directed graph 134 of FIG. 3 and the exemplary max heap data structure 136 of FIG. 4. As seen in FIG. 5, the instructions 132(0)-132(7) of FIG. 2 have been reordered based on the criticality metrics 304(0)-304(7) of FIGS. 3 and 4. In addition, the compiler 128 has also performed load latency hiding by moving the instruction 132(5) before the long sync that is performed after instructions 132(0) and 132(1). As a result, a total of 105 processor cycles are consumed by executing the instructions 132(0)-132(7) according to the optimized schedule 138, which represents a 48.53% performance improvement compared to the initial schedule 130.

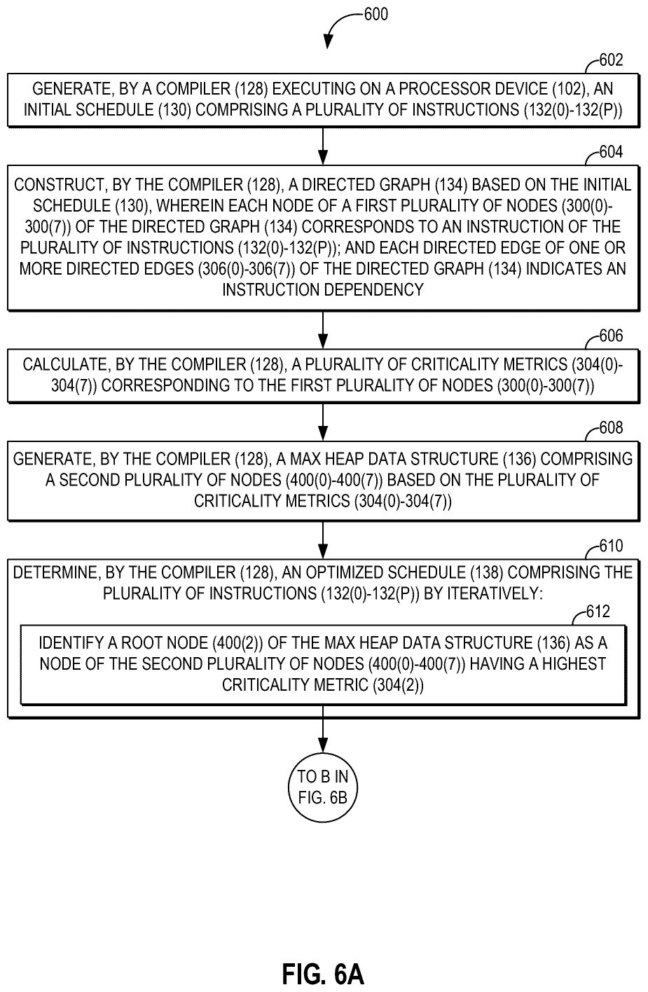

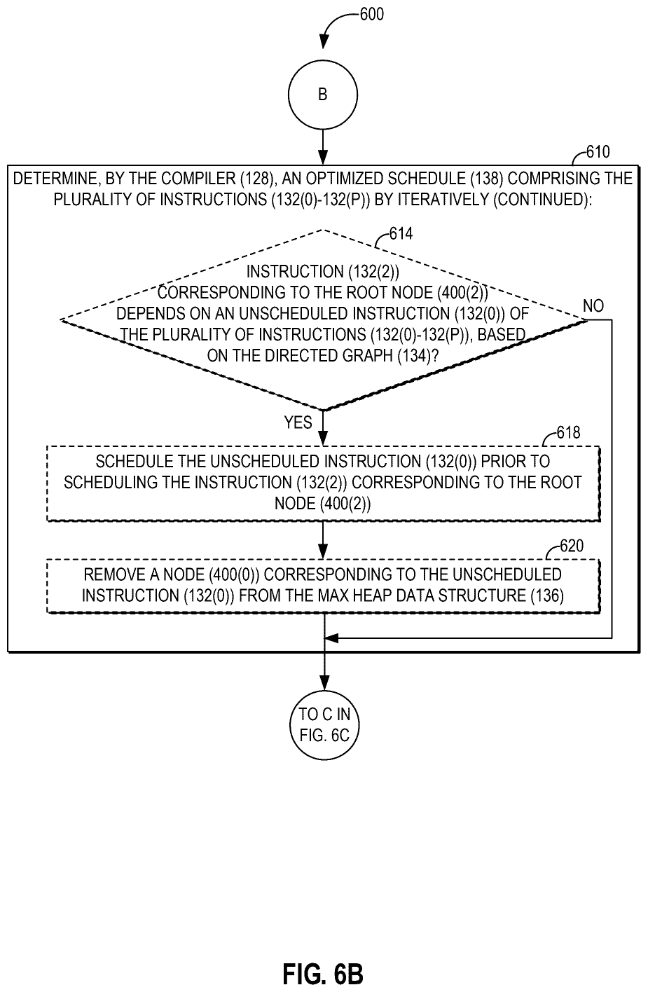

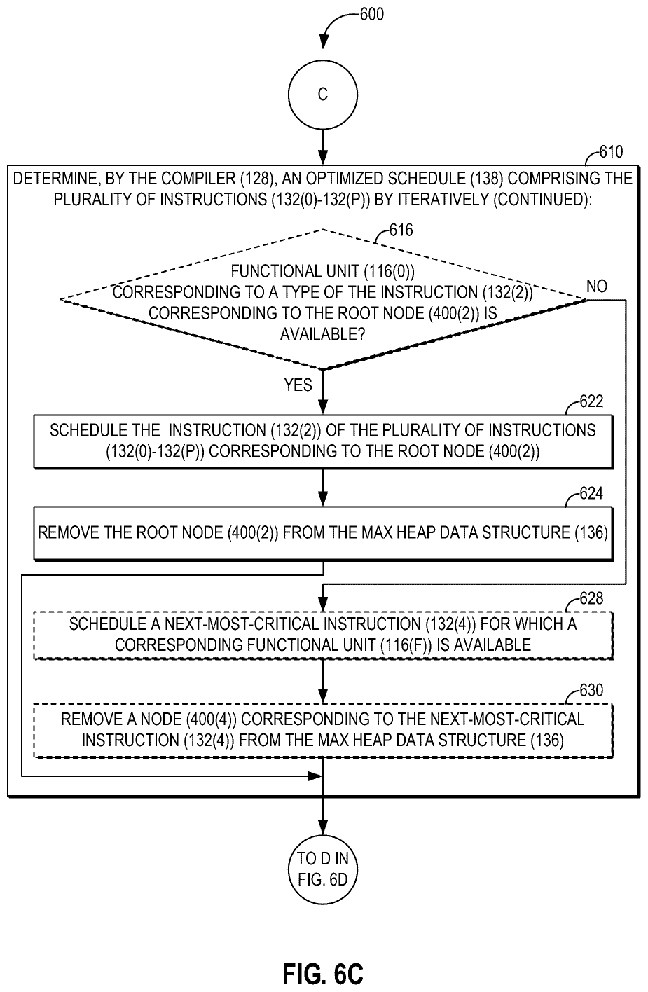

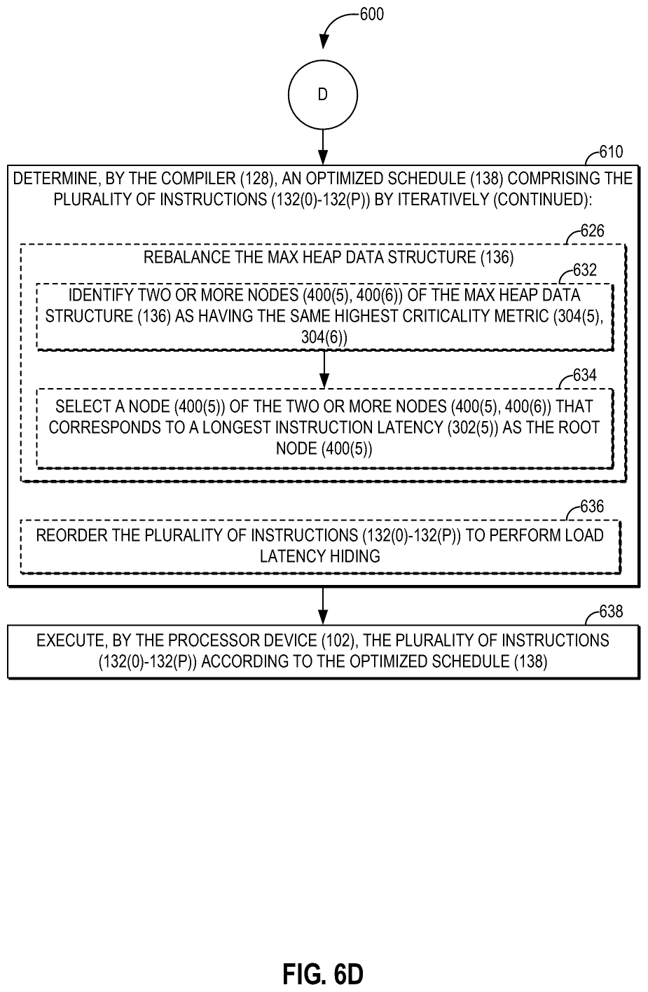

To illustrate operations performed by the processor device 102 of FIG. 1 for performing criticality-based instruction scheduling according to some aspects, FIGS. 6A-6D provide a flowchart showing exemplary operations 600. For the sake of clarity, elements of FIGS. 1-5 are referenced in describing FIGS. 6A-6D. It is to be understood that some aspects may provide that some operations illustrated in FIGS. 6A-6D may be performed in an order other than that illustrated herein, and/or may be omitted.

The exemplary operations 600 begin in FIG. 6A with a compiler (e.g., the compiler 128 of FIG. 1) executing on a processor device (such as the processor device 102 of FIG. 1) generating an initial schedule (e.g., the initial schedule 130 of FIGS. 1-2) comprising a plurality of instructions (such as the instructions 132(0)-132(P) of FIG. 1) (block 602). The compiler 128 constructs a directed graph (e.g., the directed graph 134 of FIGS. 1 and 3) based on the initial schedule 130, wherein each node of a first plurality of nodes (such as the nodes 300(0)-300(7) of FIG. 3) of the directed graph 134 corresponds to an instruction of the plurality of instructions 132(0)-132(P), and each directed edge of one or more directed edges (e.g., the directed edges 306(0)-306(7) of FIG. 3) of the directed graph 134 indicates an instruction dependency (block 604). The compiler 128 next calculates a plurality of criticality metrics (such as the criticality metrics 304(0)-304(7) of FIG. 3) corresponding to the first plurality of nodes 300(0)-300(7) (block 606). The compiler 128 then generates a max heap data structure (e.g., the max heap data structure 136 of FIGS. 1 and 4) comprising a second plurality of nodes (such as the nodes 400(0)-400(7) of FIG. 4) based on the plurality of criticality metrics 304(0)-304(7) (block 608).

The compiler 128 determines an optimized schedule (e.g., the optimized schedule 138 of FIGS. 1 and 5) comprising the plurality of instructions 132(0)-132(P) by iteratively performing a series of operations (i.e., until all of the nodes 400(0)-400(7) have been removed from the max heap data structure 136) (block 610). The compiler 128 first identifies a root node (such as the root node 400(2) of FIG. 4) of the max heap data structure 136 as a node of the second plurality of nodes 400(0)-400(7) having a highest criticality metric 304(2) (block 612). The exemplary operations 600 in some aspects continue at block 614 of FIG. 6B.

Turning now to FIG. 6B, the operations of block 610 of FIG. 6A for determining the optimized schedule 138 continue. According to some aspects, the compiler 128 may determine whether an instruction (e.g., the instruction 132(2) of FIG. 1) corresponding to the root node 400(2) depends on an unscheduled instruction (such as the instruction 132(0) of FIG. 1) of the plurality of instructions 132(0)-132(P), based on the directed graph 134 (block 614). If not, the exemplary operations may continue at block 616 of FIG. 6C. However, if the compiler 128 determines at decision block 614 that the instruction 132(2) corresponding to the root node 400(2) depends on the unscheduled instruction 132(0) of the plurality of instructions 132(0)-132(P), the compiler 128 schedules the unscheduled instruction 132(0) prior to scheduling the instruction 132(2) corresponding to the root node 400(2) (block 618). The compiler 128 also removes a node (e.g., the node 400(0) of FIG. 4) corresponding to the unscheduled instruction 132(0) from the max heap data structure 136 (block 620). The exemplary operations 600 according to some aspects may continue at block 616 of FIG. 6C.

Referring now to FIG. 6C, further operations of block 610 of FIG. 6A for determining the optimized schedule 138 continue. Some aspects may provide that the compiler 128 determines whether a functional unit (e.g., the functional unit 116(0) of FIG. 1) corresponding to a type of the instruction 132(2) corresponding to the root node 400(2) is available (block 616). If the compiler 128 determines at decision block 616 that the functional unit 116(0) is available (or if the decision block 614 of FIG. 6B and/or the decision block 616 are not implemented in a given aspect), the compiler 128 schedules the instruction 132(2) of the plurality of instructions 132(0)-132(P) corresponding to the root node 400(2) (block 622). The compiler 128 also removes the root node 400(2) from the max heap data structure 136 (block 624). The exemplary operations 600 in some aspects may continue at block 626 of FIG. 6D. However, if the compiler 128 determines at decision block 616 that the functional unit 116(0) is not available, the compiler 128 schedules a next-most-critical instruction (e.g., the instruction 132(4) of FIG. 2) for which a corresponding functional unit (such as the functional unit 116(F) of FIG. 1) is available (block 628). The compiler 128 then removes a node (e.g., the node 400(4) of FIG. 4) corresponding to the next-most-critical instruction 132(4) from the max heap data structure 136 (block 630). The exemplary operations 600 according to some aspects may continue at block 626 of FIG. 6D.

With continuing reference to FIG. 6D, further operations of block 610 of FIG. 6A for determining the optimized schedule 138 continue. Some aspects may provide that the compiler 128 rebalances the max heap data structure 136 (block 626). Some such aspects may provide that the operations of block 622 for rebalancing the max heap data structure 136 may comprise the compiler 128 identify two or more nodes (e.g., the nodes 400(5), 400(6) of FIG. 4) of the max heap data structure 136 as having the same highest criticality metric (such as the criticality metrics 304(5), 304(6) of FIGS. 3 and 4) (block 632). The compiler 128 then selects a node (e.g., the node 400(5) of FIG. 4) of the two or more nodes 400(5), 400(6) that corresponds to a longest instruction latency (such as the instruction latency 302(5) of FIG. 3) as the root node 400(5) (block 634). Some aspects may further provide that the compiler 128 reorders the plurality of instructions 132(0)-132(P) to perform load latency hiding (block 636). Finally, the processor device 102 executes the plurality of instructions 132(0)-132(P) according to the optimized schedule 138 (block 638).

The processor device according to aspects disclosed herein and discussed with reference to FIGS. 1-5 and 6A-6D may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

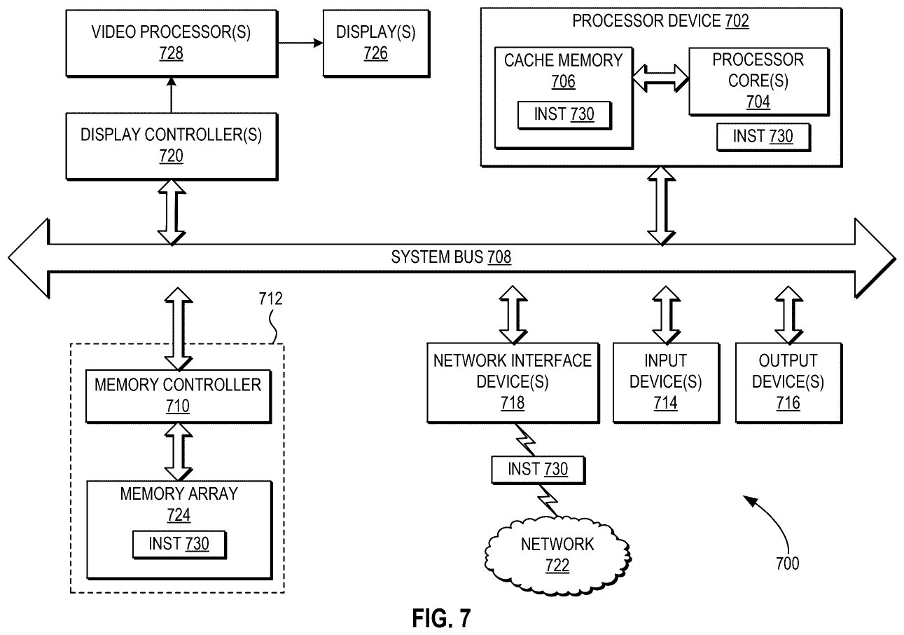

In this regard, FIG. 7 illustrates an example of a processor-based device 700, which corresponds in functionality to the processor-based device 100 of FIG. 1. In this example, the processor-based device 700 includes a processor device 702 (corresponding to the processor device 102 of FIG. 1) that comprises one or more processor cores 704 coupled to a cache memory 706. The processor device 702 is also coupled to a system bus 708 and can intercouple devices included in the processor-based device 700. As is well known, the processor device 702 communicates with these other devices by exchanging address, control, and data information over the system bus 708. For example, the processor device 702 can communicate bus transaction requests to a memory controller 710. Although not illustrated in FIG. 7, multiple system buses 708 could be provided, wherein each system bus 708 constitutes a different fabric.

Other devices may be connected to the system bus 708. As illustrated in FIG. 7, these devices can include a memory system 712, one or more input devices 714, one or more output devices 716, one or more network interface devices 718, and one or more display controllers 720, as examples. The input device(s) 714 can include any type of input device, including, but not limited to, input keys, switches, voice processors, etc. The output device(s) 716 can include any type of output device, including, but not limited to, audio, video, other visual indicators, etc. The network interface device(s) 718 can be any devices configured to allow exchange of data to and from a network 722. The network 722 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 718 can be configured to support any type of communications protocol desired. The memory system 712 can include the memory controller 710 coupled to one or more memory arrays 724.

The processor device 702 may also be configured to access the display controller(s) 720 over the system bus 708 to control information sent to one or more displays 726. The display controller(s) 720 sends information to the display(s) 726 to be displayed via one or more video processors 728, which process the information to be displayed into a format suitable for the display(s) 726. The display(s) 726 can include any type of display, including, but not limited to, a cathode ray tube (CRT), a liquid crystal display (LCD), a plasma display, a light emitting diode (LED) display, etc.

The processor-based device 700 in FIG. 7 may include a set of instructions (captioned as “INST” in FIG. 7) 730 that may be executed by the processor device 702 for any application desired according to the instructions. The instructions 730 may be stored in the memory system 712, the processor device 702, and/or the cache memory 706, each of which may comprise an example of a non-transitory computer-readable medium. The instructions 730 may also reside, completely or at least partially, within the memory system 712 and/or within the processor device 702 during their execution. The instructions 730 may further be transmitted or received over the network 722, such that the network 722 may comprise an example of a computer-readable medium.

While the computer-readable medium is described in an exemplary embodiment herein to be a single medium, the term “computer-readable medium” should be taken to include a single medium or multiple media (e.g., a centralized or distributed database, and/or associated caches and servers) that store the set of instructions 730. The term “computer-readable medium” shall also be taken to include any medium that is capable of storing, encoding, or carrying a set of instructions for execution by a processing device and that cause the processing device to perform any one or more of the methodologies of the embodiments disclosed herein. The term “computer-readable medium” shall accordingly be taken to include, but not be limited to, solid-state memories, optical medium, and magnetic medium.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor device, configured to:
generate, by executing a compiler, an initial schedule comprising a plurality of instructions;
construct, by executing the compiler, a directed graph based on the initial schedule, wherein:
   each node of a first plurality of nodes of the directed graph corresponds to an instruction of the plurality of instructions; and
   each directed edge of one or more directed edges of the directed graph indicates an instruction dependency;
calculate, by executing the compiler, a plurality of criticality metrics corresponding to the first plurality of nodes;
generate, by executing the compiler, a max heap data structure comprising a second plurality of nodes based on the plurality of criticality metrics;
determine, by executing the compiler, an optimized schedule comprising the plurality of instructions by being configured to iteratively:
   identify a root node of the max heap data structure as a node of the second plurality of nodes having a highest criticality metric;
   schedule an instruction of the plurality of instructions corresponding to the root node; and
   remove the root node from the max heap data structure; and
execute the plurality of instructions according to the optimized schedule.
   2. The processor device of clause 1, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.
   3. The processor device of any one of clauses 1-2, wherein the processor device is configured to determine the optimized schedule by being further configured to:
determine whether the instruction corresponding to the root node depends on an unscheduled instruction of the plurality of instructions, based on the directed graph; and
responsive to determining that the instruction corresponding to the root node depends on the unscheduled instruction:
   schedule the unscheduled instruction prior to scheduling the instruction corresponding to the root node; and
   remove a node corresponding to the unscheduled instruction from the max heap data structure.
      4. The processor device of any one of clauses 1-3, wherein:
the processor device is further configured to, prior to scheduling the instruction corresponding to the root node:
   determine whether a functional unit corresponding to a type of the instruction corresponding to the root node is available; and
   responsive to determining that the functional unit corresponding to the type of the instruction corresponding to the root node is not available:
      schedule a next-most-critical instruction for which a corresponding functional unit is available; and
      remove a node corresponding to the next-most-critical instruction from the max heap data structure; and
   the processor device is configured to schedule the instruction corresponding to the root node responsive to determining that the functional unit corresponding to the type of the instruction corresponding to the root node is available.
      5. The processor device of any one of clauses 1-4, wherein the processor device is further configured to rebalance the max heap data structure.
      6. The processor device of clause 5, wherein the processor device is configured to rebalance the max heap data structure by being configured to:
identify two or more nodes of the max heap data structure as having the same highest criticality metric; and
select a node of the two or more nodes that corresponds to a longest instruction latency as the root node.
   7. The processor device of any one of clauses 1-6, wherein the processor device is configured to determine the optimized schedule by being further configured to reorder the plurality of instructions to perform load latency hiding.
   8. The processor device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

### 9. a Processor Device, Comprising:

means for generating an initial schedule comprising a plurality of instructions;
means for constructing a directed graph based on the initial schedule, wherein:
   each node of a first plurality of nodes of the directed graph corresponds to an instruction of the plurality of instructions; and
   each directed edge of one or more directed edges of the directed graph indicates an instruction dependency;
means for calculating a plurality of criticality metrics corresponding to the first plurality of nodes;
means for generating a max heap data structure comprising a second plurality of nodes based on the plurality of criticality metrics;
means for determining an optimized schedule comprising the plurality of instructions by iteratively:
   identifying a root node of the max heap data structure as a node of the second plurality of nodes having a highest criticality metric;
   scheduling an instruction of the plurality of instructions corresponding to the root node; and
   removing the root node from the max heap data structure; and
means for executing the plurality of instructions according to the optimized schedule.
   10. A method for performing criticality-based instruction scheduling in processor devices, comprising:
generating, by a compiler executing on a processor device, an initial schedule comprising a plurality of instructions;
constructing, by the compiler, a directed graph based on the initial schedule, wherein:
   each node of a first plurality of nodes of the directed graph corresponds to an instruction of the plurality of instructions; and
   each directed edge of one or more directed edges of the directed graph indicates an instruction dependency;
calculating, by the compiler, a plurality of criticality metrics corresponding to the first plurality of nodes;
generating, by the compiler, a max heap data structure comprising a second plurality of nodes based on the plurality of criticality metrics;
determining, by the compiler, an optimized schedule comprising the plurality of instructions by iteratively:
   identifying a root node of the max heap data structure as a node of the second plurality of nodes having a highest criticality metric;
   scheduling an instruction of the plurality of instructions corresponding to the root node; and
   removing the root node from the max heap data structure; and
executing, by the processor device, the plurality of instructions according to the optimized schedule.
   11. The method of clause 10, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.
   12. The method of any one of clauses 10-11, wherein determining the optimized schedule comprises:
determining that the instruction corresponding to the root node depends on an unscheduled instruction of the plurality of instructions, based on the directed graph; and
responsive to determining that the instruction corresponding to the root node depends on the unscheduled instruction:
   scheduling the unscheduled instruction prior to scheduling the instruction corresponding to the root node; and
   removing a node corresponding to the unscheduled instruction from the max heap data structure.
      13. The method of any one of clauses 10-12, wherein:
the method further comprises, prior to scheduling the instruction corresponding to the root node, determining that a functional unit corresponding to a type of the instruction corresponding to the root node is available; and
scheduling the instruction corresponding to the root node is responsive to determining that the functional unit corresponding to the type of the instruction corresponding to the root node is available.
   14. The method of any one of clauses 10-13, wherein:
the method further comprises, prior to scheduling the instruction corresponding to the root node, determining that a functional unit corresponding to a type of the instruction corresponding to the root node is not available; and
responsive to determining that the functional unit corresponding to the type of the instruction corresponding to the root node is not available:
   scheduling a next-most-critical instruction for which a corresponding functional unit is available; and
   removing a node corresponding to the next-most-critical instruction from the max heap data structure.
      15. The method of any one of clauses 10-14, wherein the method further comprises rebalancing the max heap data structure.
      16. The method of clause 15, wherein rebalancing the max heap data structure comprises:
identifying two or more nodes of the max heap data structure as having the same highest criticality metric; and
selecting a node of the two or more nodes that corresponds to a longest instruction latency as the root node.
   17. The method of any one of clauses 10-16, wherein determining the optimized schedule comprises reordering the plurality of instructions to perform load latency hiding.
   18. A non-transitory computer-readable medium, having stored thereon computer-executable instructions that, when executed by a processor device, cause a dependency identifier circuit of the processor device to:
generate an initial schedule comprising a plurality of instructions;
construct a directed graph based on the initial schedule, wherein:
   each node of a first plurality of nodes of the directed graph corresponds to an instruction of the plurality of instructions; and
   each directed edge of one or more directed edges of the directed graph indicates an instruction dependency;
calculate a plurality of criticality metrics corresponding to the first plurality of nodes;
generate a max heap data structure comprising a second plurality of nodes based on the plurality of criticality metrics;
determine an optimized schedule comprising the plurality of instructions by causing the processor device to iteratively:
   identify a root node of the max heap data structure as a node of the second plurality of nodes having a highest criticality metric;
   schedule an instruction of the plurality of instructions corresponding to the root node; and
   remove the root node from the max heap data structure; and execute the plurality of instructions according to the optimized schedule.
      19. The non-transitory computer-readable medium of clause 18, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.
      20. The non-transitory computer-readable medium of any one of clauses 18-19, wherein the computer-executable instructions cause the processor device to determine the optimized schedule by causing the processor device to:
determine whether the instruction corresponding to the root node depends on an unscheduled instruction of the plurality of instructions, based on the directed graph; and
responsive to determining that the instruction corresponding to the root node depends on the unscheduled instruction:
   schedule the unscheduled instruction prior to scheduling the instruction corresponding to the root node; and
   remove a node corresponding to the unscheduled instruction from the max heap data structure.
      21. The non-transitory computer-readable medium of any one of clauses 18-20, wherein:
the computer-executable instructions further cause the processor device to, prior to scheduling the instruction corresponding to the root node:
   determine whether a functional unit corresponding to a type of the instruction corresponding to the root node is available; and
   responsive to determining that the functional unit corresponding to the type of the instruction corresponding to the root node is not available:
      schedule a next-most-critical instruction for which a corresponding functional unit is available; and
      remove a node corresponding to the next-most-critical instruction from the max heap data structure; and
the computer-executable instructions cause the processor device to schedule the instruction corresponding to the root node responsive to determining that the functional unit corresponding to the type of the instruction corresponding to the root node is available.
   22. The non-transitory computer-readable medium of any one of clauses 18-21, wherein the computer-executable instructions further cause the processor device to rebalance the max heap data structure.
   23. The non-transitory computer-readable medium of clause 22, wherein the computer-executable instructions cause the processor device to rebalance the max heap data structure by causing the processor device to:
identify two or more nodes of the max heap data structure as having the same highest criticality metric; and
select a node of the two or more nodes that corresponds to a longest instruction latency as the root node.
   24. The non-transitory computer-readable medium of any one of clauses 18-23, wherein the computer-executable instructions cause the processor device to determine the optimized schedule by causing the processor device to reorder the plurality of instructions to perform load latency hiding.

What is claimed is:

1. A processor device, configured to:
generate, by executing a compiler, an initial schedule comprising a plurality of instructions;
construct, by executing the compiler, a directed graph based on the initial schedule, wherein:
each node of a first plurality of nodes of the directed graph corresponds to an instruction of the plurality of instructions; and
each directed edge of one or more directed edges of the directed graph indicates an instruction dependency;
calculate, by executing the compiler, a plurality of criticality metrics corresponding to the first plurality of nodes;
generate, by executing the compiler, a max heap data structure comprising a second plurality of nodes based on the plurality of criticality metrics;
determine, by executing the compiler, an optimized schedule comprising the plurality of instructions by being configured to iteratively:
identify a root node of the max heap data structure as a node of the second plurality of nodes having a highest criticality metric;
schedule an instruction of the plurality of instructions corresponding to the root node; and
remove the root node from the max heap data structure; and
execute the plurality of instructions according to the optimized schedule.

2. The processor device of claim 1, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.

3. The processor device of claim 1, wherein the processor device is configured to determine the optimized schedule by being further configured to:
determine whether the instruction corresponding to the root node depends on an unscheduled instruction of the plurality of instructions, based on the directed graph; and
responsive to determining that the instruction corresponding to the root node depends on the unscheduled instruction:
schedule the unscheduled instruction prior to scheduling the instruction corresponding to the root node; and
remove a node corresponding to the unscheduled instruction from the max heap data structure.

4. The processor device of claim 1, wherein:
the processor device is further configured to, prior to scheduling the instruction corresponding to the root node:
determine whether a functional unit corresponding to a type of the instruction corresponding to the root node is available; and
responsive to determining that the functional unit corresponding to the type of the instruction corresponding to the root node is not available:
schedule a next-most-critical instruction for which a corresponding functional unit is available; and
remove a node corresponding to the next-most-critical instruction from the max heap data structure; and
the processor device is configured to schedule the instruction corresponding to the root node responsive to determining that the functional unit corresponding to the type of the instruction corresponding to the root node is available.

5. The processor device of claim 1, wherein the processor device is further configured to rebalance the max heap data structure.

6. The processor device of claim 5, wherein the processor device is configured to rebalance the max heap data structure by being configured to:
identify two or more nodes of the max heap data structure as having the same highest criticality metric; and
select a node of the two or more nodes that corresponds to a longest instruction latency as the root node.

7. The processor device of claim 1, wherein the processor device is configured to determine the optimized schedule by being further configured to reorder the plurality of instructions to perform load latency hiding.

8. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component.

9. A processor device, comprising:
means for generating an initial schedule comprising a plurality of instructions;
means for constructing a directed graph based on the initial schedule, wherein:
each node of a first plurality of nodes of the directed graph corresponds to an instruction of the plurality of instructions; and
each directed edge of one or more directed edges of the directed graph indicates an instruction dependency;
means for calculating a plurality of criticality metrics corresponding to the first plurality of nodes;
means for generating a max heap data structure comprising a second plurality of nodes based on the plurality of criticality metrics;
means for determining an optimized schedule comprising the plurality of instructions by iteratively:
identifying a root node of the max heap data structure as a node of the second plurality of nodes having a highest criticality metric;
scheduling an instruction of the plurality of instructions corresponding to the root node; and
removing the root node from the max heap data structure; and
means for executing the plurality of instructions according to the optimized schedule.

10. A method for performing criticality-based instruction scheduling in processor devices, comprising:
generating, by a compiler executing on a processor device, an initial schedule comprising a plurality of instructions;
constructing, by the compiler, a directed graph based on the initial schedule, wherein:
each node of a first plurality of nodes of the directed graph corresponds to an instruction of the plurality of instructions; and
each directed edge of one or more directed edges of the directed graph indicates an instruction dependency;
calculating, by the compiler, a plurality of criticality metrics corresponding to the first plurality of nodes;
generating, by the compiler, a max heap data structure comprising a second plurality of nodes based on the plurality of criticality metrics;
determining, by the compiler, an optimized schedule comprising the plurality of instructions by iteratively:
identifying a root node of the max heap data structure as a node of the second plurality of nodes having a highest criticality metric;
scheduling an instruction of the plurality of instructions corresponding to the root node; and
removing the root node from the max heap data structure; and
executing, by the processor device, the plurality of instructions according to the optimized schedule.

11. The method of claim 10, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.

12. The method of claim 10, wherein determining the optimized schedule comprises:
determining that the instruction corresponding to the root node depends on an unscheduled instruction of the plurality of instructions, based on the directed graph; and
responsive to determining that the instruction corresponding to the root node depends on the unscheduled instruction:
scheduling the unscheduled instruction prior to scheduling the instruction corresponding to the root node; and
removing a node corresponding to the unscheduled instruction from the max heap data structure.

13. The method of claim 10, wherein:
the method further comprises, prior to scheduling the instruction corresponding to the root node, determining that a functional unit corresponding to a type of the instruction corresponding to the root node is available; and
scheduling the instruction corresponding to the root node is responsive to determining that the functional unit corresponding to the type of the instruction corresponding to the root node is available.

14. The method of claim 10, wherein:
the method further comprises, prior to scheduling the instruction corresponding to the root node, determining that a functional unit corresponding to a type of the instruction corresponding to the root node is not available; and
responsive to determining that the functional unit corresponding to the type of the instruction corresponding to the root node is not available:
scheduling a next-most-critical instruction for which a corresponding functional unit is available; and
removing a node corresponding to the next-most-critical instruction from the max heap data structure.

15. The method of claim 10, wherein the method further comprises rebalancing the max heap data structure.

16. The method of claim 15, wherein rebalancing the max heap data structure comprises:
identifying two or more nodes of the max heap data structure as having the same highest criticality metric; and
selecting a node of the two or more nodes that corresponds to a longest instruction latency as the root node.

17. The method of claim 10, wherein determining the optimized schedule comprises reordering the plurality of instructions to perform load latency hiding.

18. A non-transitory computer-readable medium, having stored thereon computer-executable instructions that, when executed by a processor device, cause a dependency identifier circuit of the processor device to:
generate an initial schedule comprising a plurality of instructions;
construct a directed graph based on the initial schedule, wherein:
each node of a first plurality of nodes of the directed graph corresponds to an instruction of the plurality of instructions; and
each directed edge of one or more directed edges of the directed graph indicates an instruction dependency;
calculate a plurality of criticality metrics corresponding to the first plurality of nodes;
generate a max heap data structure comprising a second plurality of nodes based on the plurality of criticality metrics;
determine an optimized schedule comprising the plurality of instructions by causing the processor device to iteratively:
identify a root node of the max heap data structure as a node of the second plurality of nodes having a highest criticality metric;
schedule an instruction of the plurality of instructions corresponding to the root node; and
remove the root node from the max heap data structure; and
execute the plurality of instructions according to the optimized schedule.

19. The non-transitory computer-readable medium of claim 18, wherein each criticality metric of the plurality of criticality metrics comprises a sum of instruction latencies of all instructions directly and indirectly dependent on an instruction of the plurality of instructions that corresponds to a node of the first plurality of nodes that corresponds to the criticality metric.

20. The non-transitory computer-readable medium of claim 18, wherein the computer-executable instructions cause the processor device to determine the optimized schedule by causing the processor device to:
determine whether the instruction corresponding to the root node depends on an unscheduled instruction of the plurality of instructions, based on the directed graph; and
responsive to determining that the instruction corresponding to the root node depends on the unscheduled instruction:
schedule the unscheduled instruction prior to scheduling the instruction corresponding to the root node; and
remove a node corresponding to the unscheduled instruction from the max heap data structure.

21. The non-transitory computer-readable medium of claim 18, wherein:
the computer-executable instructions further cause the processor device to, prior to scheduling the instruction corresponding to the root node:
determine whether a functional unit corresponding to a type of the instruction corresponding to the root node is available; and
responsive to determining that the functional unit corresponding to the type of the instruction corresponding to the root node is not available:
schedule a next-most-critical instruction for which a corresponding functional unit is available; and
remove a node corresponding to the next-most-critical instruction from the max heap data structure; and
the computer-executable instructions cause the processor device to schedule the instruction corresponding to the root node responsive to determining that the functional unit corresponding to the type of the instruction corresponding to the root node is available.

22. The non-transitory computer-readable medium of claim 18, wherein the computer-executable instructions further cause the processor device to rebalance the max heap data structure.

23. The non-transitory computer-readable medium of claim 22, wherein the computer-executable instructions cause the processor device to rebalance the max heap data structure by causing the processor device to:
identify two or more nodes of the max heap data structure as having the same highest criticality metric; and
select a node of the two or more nodes that corresponds to a longest instruction latency as the root node.

24. The non-transitory computer-readable medium of claim 18, wherein the computer-executable instructions cause the processor device to determine the optimized schedule by causing the processor device to reorder the plurality of instructions to perform load latency hiding.
